(19) United States
(12) Patent Application Publication
(10) Pub. No.: US 2004/0034387 A1
(43) Pub. Date: Feb. 19, 2004

(54) Occlusion device and method of performing an anastomosis

(75) Inventor: Mark Alexander John Newman, Claremont (AU)

Correspondence Address: Marger Johnson & McCollom, P.C., 1030 SW Morrison Street, Portland, OR, 97205, US

(73) Assignees: The Minister for Health, incorporated as the board of Sir Charles Gairdner Hospital, Nedlands (AU); Mark Alexander John Newman, Claremont (AU)

(21) Appl. No.: 10/640,174

(22) Filed: Aug. 12, 2003

(30) Foreign Application Priority Data
Aug. 13, 2002 (AU) 2002950736

(51) Int. Cl. A61D 1/00

(52) U.S. Cl. 606/213

(57) ABSTRACT

An occlusion device (1) to occlude an opening (78) in the wall of a blood vessel (62) having an occludent member (2) that may be gripped using knots (8) in a thread (4) so that the occludent member (2) can be inserted into the blood vessel (62) through the opening (78). The occludent member (2) has an exterior surface (14) and an interior surface (15). In use, the edge (84) of the opening (78) contacts the exterior surface (14) to thereby occlude the opening (78) and the interior surface (15) is filled with blood flowing in the blood vessel (62). The thread (4) extends from the exterior surface (14) on the exterior of the occludent member (2) for extraction of the occludent member (2) from the blood vessel (62) through the opening (78).

### PRIORITY INFORMATION

This application claims priority from Australian Provisional Patent Application No. 2002950736 filed Aug. 13, 2002.

### FIELD OF THE INVENTION

The present invention relates to an occlusion device to occlude an opening and has particular application in an anastomosis procedure such as, for example, coronary artery bypass graft (CABG).

### BACKGROUND ART

This specification describes aspects of prior art anastomosis procedures and devices. However, neither such aspects of prior art anastomosis procedures and devices nor the description contained herein of such aspects of prior art anastomosis procedures and devices is to be taken as forming part of the common general knowledge solely by virtue of the inclusion herein of reference to and description of such aspects of prior art anastomosis procedures and devices.

Coronary artery bypass graft (CABG) surgery frequently requires the anastomosis of a graft blood vessel to the ascending aorta. This anastomosis necessitates occlusion of the ascending aorta. This can be with either a partial occlusion side clamp or a complete occlusion cross clamp.

The complete occlusion can be used only when cardiopulmonary bypass is used for the operation and during this occlusion there is no blood flow to the heart. The most severe complication of CABG is stroke related to dislodgement of atherosclerotic material from the aortic wall. This is related to clamping of the aorta.

CABG without cardiopulmonary bypass (OPCAB) has been introduced to try and reduce the complications of CABG. In OPCAB a side clamp is required to partially occlude the aorta to perform a proximal anastomosis. This potentially reduces the benefit obtained of not using cardiopulmonary bypass. The other complication seen with side clamping of the aorta is damage to the aortic wall, which can result in the fatal complication of aortic dissection. Side clamping also reduces the lumenal cross-section of the aorta impairing blood flow to the organs and may predispose to renal failure.

In order to avoid the necessity of clamping the aorta, one prior art device joins the graft to the aorta with a stent-like device. This, however, necessitates that the proximal anastomosis be performed first before any distal anastomoses and it can be used only with saphenous vein. The device is also very expensive.

The aim of the present invention is to allow anastomosis of any suitable graft to the aorta without the need for a side clamp or cross clamp.

### DISCLOSURE OF THE INVENTION

In accordance with one aspect of the present invention there is provided an occlusion device to occlude an opening in the wall of a blood vessel comprising a substantially elastically deformable occludent member, means to be griped for insertion of said occludent member into the blood vessel through the opening in the blood vessel, said occludent member having a first surface and a second surface, said first surface arranged such that, in use, the edge of the opening in the blood vessel contacts said first surface such that the opening is thereby occluded and said second surface defines an interior space of said occludent member that is arranged, in use, to be filled with blood flowing in said blood vessel, and extraction means extending from said second surface of said occludent member for extraction of said occludent member from the blood vessel through the opening.

Preferably, said occludent member has a cross-sectional size that varies between first and second locations of the occludent member such that at the first location the cross-sectional size of the occludent member is less than the diameter of the opening through which the occludent member is insertable and at said second location said cross-sectional size of said occludent member is greater than the diameter of the opening through which said occludent member is insertable.

Preferably, the cross-sectional size of said occludent member increases with distance in the direction from said first location to said second location.

Preferably, said occludent member has an opening at said second location.

Preferably, said means to be gripped is provided in said interior space.

Preferably, said extraction means comprises a thread and said means to be gripped comprises at least one knot in said thread, said knot being located in said interior space.

Preferably, securing means is provided at the distal end of said extraction means remote from said occludent member.

Preferably, said occludent member is substantially cone shaped.

Preferably, at least said first surface of said occludent member has a relatively low coefficient of friction.

Preferably, an apex member is provided at said interior space of said occludent member to reinforce the upper region of said occludent member.

Preferably, said apex member also seals the upper region of said occludent member.

Preferably, said occludent member is made of a high strength material that is substantially resistant to piercing by a suture needle.

In accordance with another aspect of the present invention there is provided a method of performing an anastomosis of a first blood vessel and a second blood vessel comprising:

making an opening in said first blood vessel,

inserting an occlusion device through said opening and into the lumen of said first blood vessel,

orientating said occlusion device to occlude said opening,

performing sutures between said first blood vessel and said second blood vessel and leaving a selected number of adjacent sutures loose,

extracting said occlusion device from said lumen of said first blood vessel, and

tightening said selected number of adjacent sutures to complete the anastomosis of said first blood vessel and said second blood vessel.

Preferably, orientating said occlusion device to occlude said opening comprises contacting the edge of said opening in said first blood vessel with a surface of said occlusion device such that a portion of said occlusion device projects from the opening and is positioned exterior of said first blood vessel.

Preferably, the method further comprises leaving at least the last two adjacent sutures loose, and tightening said at least two adjacent sutures after said occlusion device has been extracted from said lumen of said first blood vessel.

### BRIEF DESCRIPTION OF THE DRAWINGS

The present invention will now be described, by way of example, with reference to the accompanying drawings, in which:

FIG. 1 shows a first embodiment of an occlusion device in accordance with one aspect of the present invention;

FIG. 2 is a second view of the occlusion device shown in FIG. 1 with the apex region of the occludent member cut away;

FIG. 3 is a view of the occlusion device shown in FIG. 1 in use;

FIGS. 4, 5, 6, 7, 8, 9, 10 and 11 are sequential views of a method of performing an anastomosis procedure in accordance with another aspect of the present invention using the occlusion device shown in FIG. 1,

FIG. 12 is a plan view of the occludent member of the occlusion device during its insertion through an opening to be occluded thereby; and

FIG. 13 is a sectional view through an aorta showing the occlusion device in position and the passage of a suture needle through the wall of the aorta.

### BEST MODE(S) FOR CARRYING OUT THE INVENTION

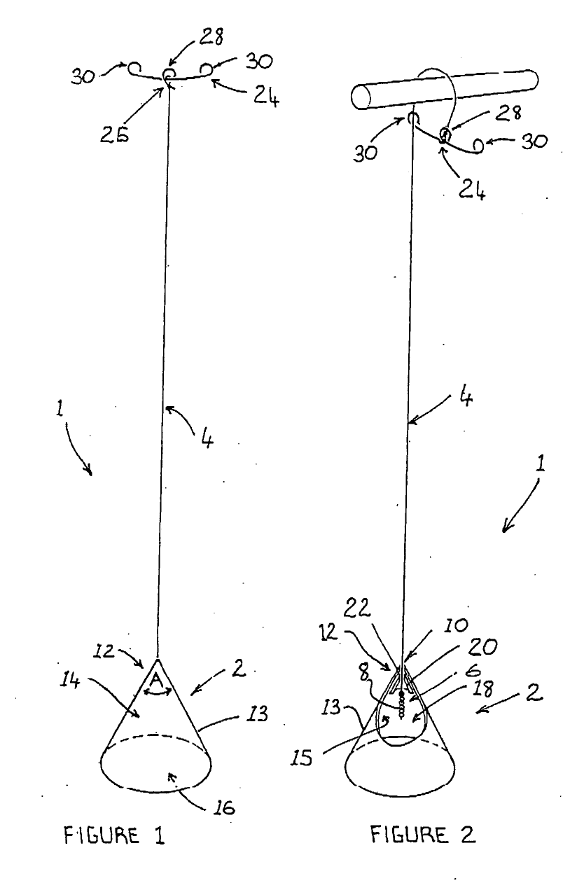

In FIGS. 1 and 2 there is shown an occlusion device 1 comprising a substantially elastically deformable occludent member 2 and a thread 4 extending from the occludent member 2. The occlusion device 1 is provided with means 6 that can be gripped such that the occludent member 2 is insertable through an opening to be occluded. The means 6 that can be gripped may be provided as knots 8 at the proximal end of the thread 4. The knots 8 also serve to securely retain the proximal end of the thread 4 with the occludent member 2, with the thread 4 extending through an opening 10 in an upper region 12 of the occludent member 2.

However, the means 6 that can be gripped may be provided in alternative forms. For example, the means 6 that can be gripped may be provided as a lug. The thread 4 may be retained with the occludent member 2 by means other than the knots 8. For example, the thread 4 may be affixed to the upper region 12 of the occludent member 2.

The occludent member 2 comprises a wall 13 having an exterior surface 14, on the exterior of the occludent member 2, and an interior surface 15.

The interior surface 15 of the wall 13 surrounds an interior space 18.

The occludent member 2 has an opening 16, to the interior space 18, from which the wall 13 of the occludent member 2 tapers to the narrower upper region 12 thereof.

The occludent member 2 is substantially cone shaped.

The interior space 18 of the occludent member 2 is accessible via the opening 16.

The upper region 12 of the occludent member 2 forms the apex region thereof.

The thread 4 extends from the exterior surface 14 of the occludent member 2, at the apex region thereof, on the exterior of the occludent member 2.

The upper region 12 of the occludent member 2 is provided with an apex member 20 located adjacent the interior surface 15 of the wall 13 in the interior space 18 of the occludent member 2. The apex member 20 provides reinforcement to the upper region 12 of the occluden member 2. The apex member 20 also acts to seal the upper region 12 of the occludent member 2. The apex member 20 may be substantially cone shaped.

In the case that the proximal end of the thread 4 is located in the interior space 18 of the occludent member 2 (as shown in FIG. 2), the thread 4 also extends through an opening 22 in the apex member 20.

A securing member 24 is provided at the distal end 26 of the thread 4. The securing member 24 is provided as a rod-member having a loop 28 therein, to which the distal end 26 of the thread 4 is attached, and a pair of hooks 30 are provided at each end of the securing member 24.

The occludent member 2 is made of high strength material and at least the exterior surface 14 has a relatively low co-efficient of friction.

For example, the occludent member 2 may be made of poly-para-phenylene terephthalamide (commercially available under the product trade name KEVLAR) and at least the exterior surface 14 may be coated with a synthetic resin composed of polytetrafluoroethylene (commercially available under the product trade name TEFLON).

The occludent member 2 may be dimensioned such that the diameter of the opening 16 is approximately one centimetre and the height of the occludent member 2, i.e. the distance from the centre of the opening 16 to the tip or apex of the upper region 12, is also approximately one centimetre. The apex angle A at the upper region 12 of the occludent member 2 may be in the range from substantially 45° to substantially 60°.

The apex member 20 may be made from the same material as the occludent member 2.

The thread 4 may be braided surgical thread.

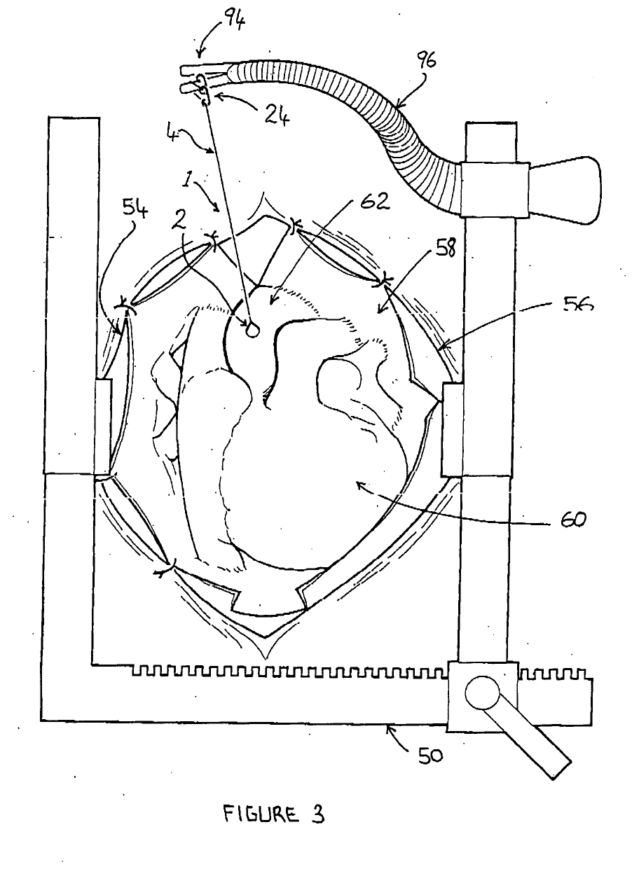

The manner of operation and use of the occlusion device 1 of the present invention will now be described with particular reference to FIGS. 3 to 13 of the accompanying drawings.

FIG. 3 shows the occlusion device 1 in position for an anastomosis procedure, being a coronary artery bypass grafting (CABG) procedure. FIG. 3 shows a retractor 50 gripping and holding apart opposed halves of the sternum of a patient, the sternum having been previously sawn in half by a surgeon. Spreading the sternum halves apart as shown at 54 and 56, respectively, provides the surgeon with access to the thoracic cavity 58 of the patient. This allows the surgeon to access the heart, shown generally at 60, of the patient and, in particular, to access the aorta 62. The aorta 62 is the site of the proximal anastomosis at which the occlusion device 1 is shown in use in FIG. 3.

The method of performing an anastomosis of blood vessel 85 to the aorta 62 of the patient in the CABG procedure will now be described.

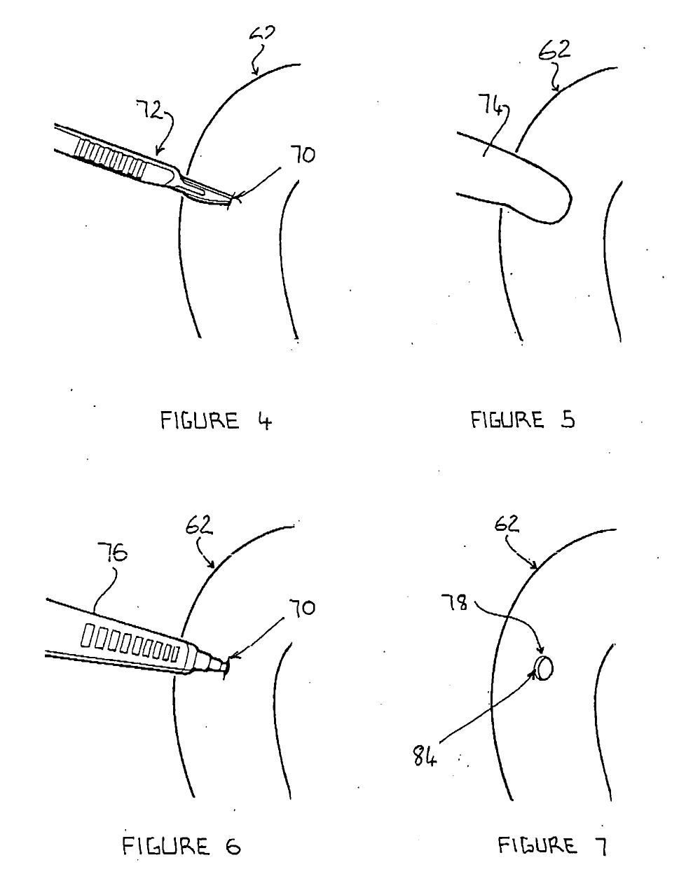

Firstly, an incision 70 is made by the surgeon in the wall of the aorta 62 with a scalpel 72, as shown in FIG. 4. The surgeon temporarily occludes the incision 70 with his or her finger 74, as illustrated in FIG. 5.

Next, the surgeon, using an aortic punch 76, forms an opening 78 in the aorta 62 at the site of the incision 70, as shown in FIG. 6. Once the opening 78 (shown in FIG. 7) has been made in the aorta 62, the surgeon again uses his finger 74 to temporarily occlude the opening 78.

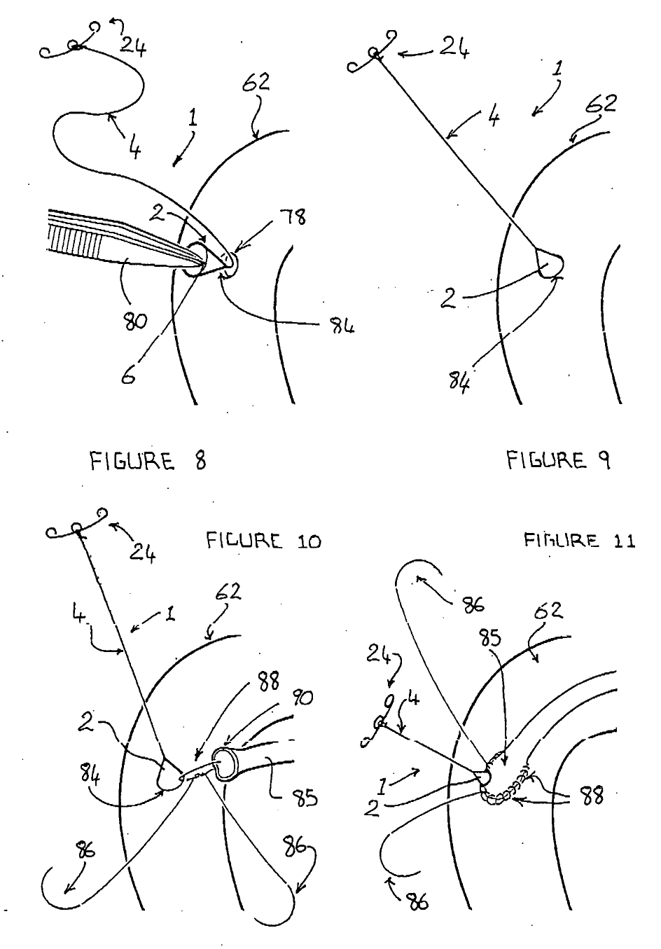

Next, the surgeon grips the means 6 that can be gripped, which may be the knots 8 in the thread 4, using forceps 80 and positions the occludent member 2 adjacent the site of the opening 78 with the upper region 12 of the occludent member 2 facing the opening 78. The surgeon then removes his or her finger 74 from the opening 78 and inserts the occludent member 2 through the opening 78, as shown in FIG. 8, into the aorta 62.

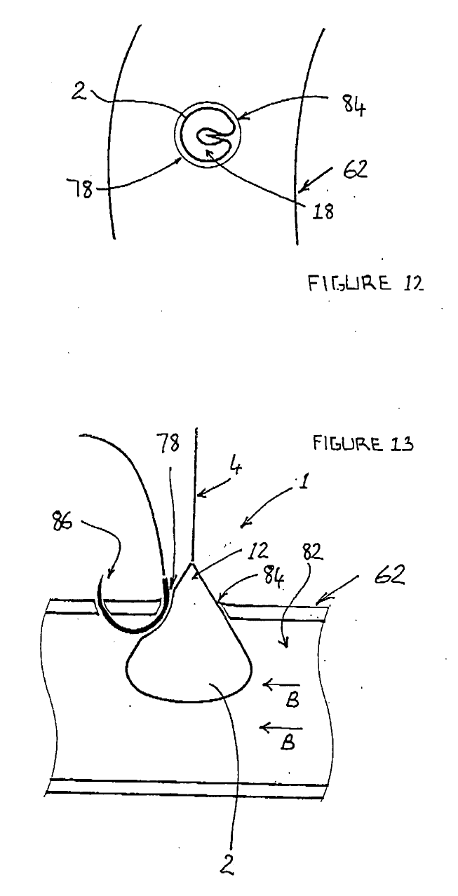

As the occludent member 2 passes through the opening 78, it deforms as shown in FIG. 12.

The occludent member 2 is dimensioned such that at the upper region 12 its cross-sectional diameter is less than the diameter of the opening 78 through which the occludent member 2 is to pass and the cross-sectional diameter at its base, adjacent the opening 16, is greater than the diameter of the opening 78 through which it is to pass. The cross-sectional diameter of the occludent member 2 increases with distance from the upper region 12 to the opening 16, due to the tapering of the wall 13. The thread 4 extends from the upper region 12 on the exterior of the occludent member 2.

The occludent member 2 deforms by the wall 13 thereof partially collapsing into the interior space 18 within the occludent member 2 such that the entire occludent member 2 passes through the opening 78 and into the lumen 82 of the aorta 62.

Once the entire occludent member 2 has been inserted into the lumen 82 of the aorta 62, the occludent member 2 returns to its original shape, i.e. its shape prior to insertion through the opening 78 and into the lumen 82, such that the occludent member 2 is again in its undeformed condition and thereby regains its undeformed shape. This is due to the occludent member 2 being elastically deformable.

Once the occludent member 2 is located within the lumen 82 of the aorta 62, the surgeon pulls on the thread 4. This inverts the occludent member 2 to occlude the opening 78, with the upper region 12 protruding back through the opening 78 out of the lumen 82 of the aorta 62, as shown in FIG. 9. The occludent member 2 is now in its occluding position.

The securing device 24 is then used to secure the occludent member 2 in its occluding position. This may be done by looping the thread 4 about a tissue stabilizer 94 that is attached to the retractor 50. The thread 4 may then be looped under one of the hooks 30 and the adjustable arm 96 of the tissue stabilizer 94 positioned to sufficiently tension the thread 4 as is further described below.

Sufficient tension is applied to the thread 4 to bring the exterior surface 14 of the occludent member 2 into sealing contact with the edge 84 of the opening 78. This is shown in FIGS. 10 and 13. The flow of blood in the aorta 62, shown by arrows B in FIG. 13, enters the interior space 18 of the occludent member 2 via the opening 16 and provides positive pressure against the interior surface 15 of the wall 13 of the occludent member 2 to force the exterior surface 14 into close sealing contact with the edge 84 of the opening 78. In this way, in practice, only a relatively small tension force is required on the thread 4 to maintain the surface 14 in sealing contact with the edge 84 of the opening 78 to retain the occludent member 2 in its occluding position. This prevents escape of blood via the opening 78.

Alternatively, the tension in the thread 4 may be maintained manually, i.e. by an assistant to the surgeon, without need for a tissue stabilizer 94 or other instrument.

Since the cross-sectional diameter of the occludent member 2 varies between the upper region 12 and the opening 16, the upper region 12 of the occludent member 2 protrudes from the opening 78 until the exterior surface 14 of the occludent member 2 contacts the edge 84 of the opening 78. Since the occludent member 2 has a cross-sectional diameter at the opening 16 that is greater than the diameter of the opening 78, the occludent member 2 cannot pass through the opening 78 and out of the lumen 82 of the aorta 62 when the occludent member 2 is in its occluding position. Furthermore, the material from which the occludent member 2 is made has sufficient rigidity that it cannot deform and collapse merely under the pressure being exerted on it by the blood flow in the lumen 82.

The apex member 20 acts to seal the upper region 12 of the occludent member 2 so that blood does not leak from the upper region 12 of the occludent member 2.

The surgeon is then able to suture the graft blood vessel 85 in an end-to-side anastomosis procedure with the aorta 62. This is shown in FIG. 10. The graft blood vessel 85 may be any free graft such as saphenous vein, radial artery or internal thoracic artery harvested from the patient upon whom the CABG procedure is being performed. During the suturing, a suture needle 86 is used to sew sutures 88 to graft the blood vessel 85 to the aorta 62. During the suturing procedure, the occludent member 2 remains in position to occlude the opening 78. The suture needle 86 is passed through the blood vessel 85 adjacent its end 90 and is skimmed off the exterior surface 14 of the occludent member 2 and then passed outwardly through the wall of the aorta 62. The material of the occludent member 2 is resistant to penetration by the suture needle 86.

Once the suturing procedure has been completed with the last two sutures 88 from each end, i.e. the last two adjacent sutures 88, being left loose, the surgeon pulls on the thread 4. This causes the occludent member 2 to deform in similar manner as hereinbefore described with reference to the insertion procedure of the occludent member 2 through the opening 78. Although a smaller opening is now available for extraction of the occludent member 2 from the lumen 82 of the aorta 62, the occludent member 2 is able to deform sufficiently and the occludent member 2 is extracted. The surgeon then pulls up on the ends of the last two adjacent sutures 88, that were left loose, to tighten those sutures 88 between the blood vessel 85 and the aorta 62. This completes the proximal anastomosis.

The apex member 20 also provides reinforcement to the upper region 12 of the occludent member 2 to ensure that the upper region 12 can sustain the force placed on it when the surgeon pulls on the thread 4 to extract the occludent member 2 from the lumen 82 of the aorta 62.

The surgeon then performs the grafting of the other end of the blood vessel 85 to complete the anastomosis of the blood vessel 85. In the case of a CABG, the surgeon would perform the distal anastomosis to graft the other end of the blood vessel 85 to the coronary artery. However, the present invention permits the proximal anastomosis or the distal anastomosis to be performed first.

In view of the high level of hygiene practised in surgical procedures to avoid contamination, the occlusion device 1 of the present invention would, in practice, be a “single procedure” device. Thus, the patient undergoing the surgical procedure may have more than one anastomosis performed during the surgical procedure and the occlusion device 1 may be used for each anastomosis procedure. However, at the end of the anastomosis procedures during that surgical procedure for that patient, the occlusion device 1 is discarded. Thus, the ability of the occludent member 2 to elastically deform is required for only a limited number of anastomosis procedures. Thus, it is not necessary that the occludent member 2 is elastically deformable for a large, or indeed, indefinite number, of anastomosis procedures.

Whilst the preceding embodiment has been described with particular reference to a CABG procedure, it will be understood that the method previously hereinbefore described may be used to graft a first blood vessel to a second blood vessel at any required site.

Modifications and variations such as would be apparent to a skilled addressee are deemed to be within the scope of the present invention.

Throughout the specification, unless the context requires otherwise, the word “comprise” or variations such as “comprises” or “comprising”, will be understood to imply the inclusion of a stated integer or group of integers but not the exclusion of any other integer or group of integers.

I claim:

1. An occlusion device to occlude an opening in the wall of a blood vessel comprising a substantially elastically deformable occludent member, means to be griped for insertion of said occludent member into the blood vessel through the opening in the blood vessel, said occludent member having a first surface and a second surface, said first surface arranged such that, in use, the edge of the opening in the blood vessel contacts said first surface such that the opening is thereby occluded and said second surface defines an interior space of said occludent member that is arranged, in use, to be filled with blood flowing in said blood vessel, and extraction means extending from said second surface of said occludent member for extraction of said occludent member from the blood vessel through the opening.

2. An occlusion device according to claim 1, wherein said occludent member has a cross-sectional size that varies between first and second locations of the occludent member such that at the first location the cross-sectional size of the occludent member is less than the diameter of the opening through which the occludent member is insertable and at said second location said cross-sectional size of said occludent member is greater than the diameter of the opening through which said occludent member is insertable.

3. An occlusion device according to claim 1, wherein an apex member is provided at said interior space of said occludent member to reinforce the upper region of said occludent member.

4. An occlusion device according to claim 2, wherein the cross-sectional size of said occludent member increases with distance in the direction from said first location to said second location.

5. An occlusion device according to claim 2, wherein said occludent member has an opening at said second location.

6. An occlusion device according to claim 3, wherein said apex member also seals the upper region of said occludent member.

7. An occlusion device according to claim 1, wherein said means to be gripped is provided in said interior space.

8. An occlusion device according to claim 1, wherein said extraction means comprises a thread and said means to be gripped comprises at least one knot in said thread, said knot being located in said interior space.

9. An occlusion device according to claim 1, wherein securing means is provided at the distal end of said extraction means remote from said occludent member.

10. An occlusion device according to claim 1, wherein said occludent member is substantially cone shaped.

11. An occlusion device according to claim 1, wherein at least said first surface of said occludent member has a relatively low coefficient of friction.

12. An occlusion device according to claim 1, wherein said occludent member is made of a high strength material that is substantially resistant to piercing by a suture needle.

13. A method of performing an anastomosis of a first blood vessel and a second blood vessel comprising:
making an opening in said first blood vessel,
inserting an occlusion device through said opening and into the lumen of said first blood vessel,
orientating said occlusion device to occlude said opening,
performing sutures between said first blood vessel and said second blood vessel and leaving a selected number of adjacent sutures loose,
extracting said occlusion device from said lumen of said first blood vessel, and tightening said selected number of adjacent sutures to complete the anastomosis of said first blood vessel and said second blood vessel.

14. A method according to claim 13, wherein orientating said occlusion device to occlude said opening comprises contacting the edge of said opening in said first blood vessel with a surface of said occlusion device such that a portion of said occlusion device projects from the opening and is positioned exterior of said first blood vessel.

15. A method according to claim 13, further comprising leaving at least the last two adjacent sutures loose, and tightening said at least last two adjacent sutures after said occlusion device has been extracted from said lumen of said first blood vessel.
